(19) United States
(12) Patent Application Publication
(10) Pub. No.: US 2026/0062068 A1
(43) Pub. Date: Mar. 5, 2026

(54) JOB BOX WITH FLUSH AND DOUBLE HINGED LID

(71) Applicant: DYNAMIC MANUFACTURING GROUP LLC, PALMETTO, FL (US)

(72) Inventors: Ronald Lee, Jr., Ruskin, FL (US); Anthony Sansone, Parrish, FL (US); Bradly Martin, Sarasota, FL (US)

(21) Appl. No.: 18/818,537

(22) Filed: Aug. 28, 2024

(51) Int. Cl. B62D 33/04; B60R 9/06; B60R 11/06

(52) U.S. Cl. CPC B62D 33/04; B60R 9/06; B60R 11/06; B60Y 2200/14

(57) ABSTRACT

A job box has a lid assembly with an upper lid pivotally coupled to a lower lid via hinge bars. The upper lid can be opened along each of two parallel spaced apart axes to reveal a storage space within the lid assembly or to angle the upper lid for displaying documents. The lid assembly is hingedly coupled to a tool storage box with recessed hinges that enable positioning flush against a wall.

This invention relates generally to toolboxes, and, more particularly, to a toolbox (aka job box) that fits within and is configured for mounting in the bed of a pickup truck.

### BACKGROUND OF THE INVENTION

Job boxes designed to fit and mount in the bed of a pickup truck typically have a few key components and a structure optimized for durability, security, and accessibility. The body may provide a universal fit or be shaped to fit specific truck beds. For example, a crossover job box spans the width of the truck bed behind the cab and rests on the bed rails. A chest job box sits on the floor of the truck bed between the bed rails, usually up against the cab.

The body is typically comprised of a durable sheet metal. Many have a polished, powder-coated, or diamond plate finish for added durability and aesthetic appeal. Heavy-duty, weather-sealed hinges allow the lid to open smoothly and stay open at various angles.

Various hardware and features facilitate use. Gas struts or springs assist in lifting the lid and holding it open. Weather-resistant seals, drainage channels, and reinforced seams keep the contents dry. A durable, easy-to-operate latch ensures the lid is securely closed. Locks, typically key-operated, prevent unauthorized access. Built-in compartments or removable trays organize tools and small parts. Holders for wrenches, screwdrivers, and other hand tools, are typically provided. Some job boxes come with interior LED lighting for visibility in low light conditions. Some may include built-in power outlets for charging tools or devices on the go. Strong handles, typically on the sides, facilitate removal and transport when needed.

Heavy-duty brackets, bolts, and clamps secure the job box to the truck bed. These are typically designed to be universal but may require drilling or specific fitting for some trucks. Some include rubber pads or gaskets between the job box and truck bed to reduce vibration, prevent scratches, and ensure a snug fit.

Despite the numerous features, job boxes have shortcomings. Contractors often work in dynamic, challenging environments where organization and efficiency are crucial. Having a clean raised surface to support and read documents at a job site is essential. Tables are not always available on job sites. Contractors frequently reference blueprints, schematics, construction plans, detailed specifications, material lists, assembly instructions, task lists, schedules, permits, safety documentation, inspection reports, and daily logs. A storage compartment and support surface is needed to ensure that documents are easily accessible and can be laid out fully for clear visibility. Having a surface to review, edit and sign documents with team members would facilitate better communication and collaboration. Contractors can discuss plans, make decisions, and ensure everyone is on the same page. Laying documents on the ground or other unstable surfaces can lead to them being damaged or lost. A proper surface ensures that papers are not trampled, torn, or misplaced.

Another shortcoming involves the lid and the hinges that connect the lid to the box. Many lids extend beyond the outer edges of the box. The lid and hinges require additional clearance behind the box. For this reason, the job box cannot be positioned flush against a wall, such as the wall of a bed near the cab of the truck. Any gap between the job box and the wall provides space for debris and fallen items to accumulate.

In sum, having a dedicated compartment and surface for supporting and reading documents at a job site is not just about convenience, it directly impacts the accuracy, efficiency, organization, and safety of the contractor's work. It enables them to manage complex projects more effectively, ensures clear communication, and protects vital information. Having a job box that can be positioned flush against a wall enhances efficiency by eliminating a space where items are lost.

The invention is directed to overcoming one or more of the problems and solving one or more of the needs as set forth above.

### SUMMARY OF THE INVENTION

To solve one or more of the problems set forth above, in an exemplary implementation of the invention, a job box having a dedicated compartment and surface for supporting and reading documents at a job site is provided. Additionally, the job box has a lid design that enables positioning flush against a wall, to enhances efficiency by eliminating space where items are lost.

An exemplary job box according to principles of the invention includes a box and a hinged lid assembly. Each hinge that couples the lid to the box resides within the planform of the box, meaning it does not extend past the planform (e.g., past the back panel) when the hinge is closed, opened or between closed and opened. Additionally, each hinge includes a leaf that is nested in and attached to a U-shaped edge of the lid. Another leaf of the hinge is attached to an upper ledge-like flange of the box structure. The two leaf structures are coupled with a pin, about which the leaf structures may pivot relative to each other. This hinge configuration allows the lid to be either flush (i.e., aligned) with the back panel of the box, or within the planform of the box, when the lid is opened. Thus, the job box may be positioned flush against a wall, without impeding opening of the lid.

The lid may be a double hinged lid assembly. The double hinged lid assembly is hingedly coupled to the box as described above. The double lid assembly has an upper lid and a lower lid with flanged edges that define a compartment between lids. The compartment may store documents and house storage bins. Hinge bars reside along each side of the double hinged lid, between the upper lid and lower lid. The upper lid is pivotally coupled to the hinge bars near the front edge of the double hinged lid assembly. The lower lid is pivotally coupled to the hinge bars near the back edge of the double hinged lid assembly. This configuration allows the upper lid to be pivoted open along the front edge, or the upper lid and hinges bars to be pivoted open along the back edge. This enables the job box to serve as a podium with the upper lid tilted towards a user. It also enables the lid to be pivoted open to facilitate access to the compartment.

Locks are provided for securing the lid closed against the box, and for securing the upper lid closed against the lower lid of the double hinged lid assembly. The lock for the double hinged lid includes a strike plate mounted on the lower lid or on a structure attached to the lower lid and a locking mechanism that includes a vending style lock core. The lock for securing the lid closed against the box includes a padlock with restrained shackle and a body that moves to partially cover a passage through which a hook-shaped latch extends.

In an exemplary embodiment, a job box mountable in a pickup truck bed includes a box-like base having a bottom panel and a plurality of wall panels extending upwardly from the bottom panel and defining a storage compartment with an open top. A lid assembly is hingedly coupled to the base. In a closed position the lid assembly covers the open top of the base. In an open position, the lid assembly does not cover at least a portion of the open top of the base. The amount of coverage depends upon the degree to which the lid assembly is pivoted open. The lid assembly includes a first lid and a hinge bar. The hinge bar has a first end pivotally coupled to the first lid at a first side of the lid and a second end pivotally coupled to a structure below the first lid near a second side of the first lid. The first lid is pivotable relative to the structure below the first lid about each of two spaced apart parallel axes, including a first axis near the first side, and a second axis near the second side.

A first bracket is coupled to the first lid at the first end of a hinge bar. A first pivot pin pivotally couples the first bracket to the first end of the hinge bar. A second bracket is coupled to the structure below the first lid at the second end of the hinge bar. A second pivot pin pivotally couples the second bracket to the second end of the hinge bar.

In an exemplary embodiment, there are at least two identical spaced apart parallel hinge bars. One may be positioned near the right side of a lid assembly. The other may be positioned near the left side of the lid assembly. The hinge bars are parallel and their pivot pins are aligned. Thus, the two aligned parallel spaced apart hinge bars define two parallel spaced apart axes of rotation. Each axis extends through two aligned pivot pins. With each hinge bar, a first bracket is coupled to the first lid and a first pivot pin pivotally couples the first bracket to the first end of the hinge bar. A second bracket is coupled to the structure below the first lid and a second pivot pin couples the second bracket to the second end of the hinge bar.

The structure below the first lid to which the second bracket is coupled may comprise a portion of the base, a bracket or other attachment structure attached to the base, or a second lid disposed below the first lid, i.e., between the base and first lid. The second lid may be hingedly coupled to the base (e.g., with recessed hinges). The first lid is pivotable in relation to the second lid. An angle between the first lid and second lid is a minimum when the first lid is in a closed position. The angle (i.e., magnitude of the angle, ignoring direction of rotation) between the first lid and second lid is greater than the minimum when the first lid is in an opened position. The first lid may pivot about two spaced apart parallel axes of rotation in two opposite directions of rotation.

The lid assembly is hingedly coupled to the base with at least one recessed hinge assembly within the planform of the base. The planform of the base is an outline of the base from a top view. The planform is a closed two-dimensional shape that defines the extents of the base. In a top view, if an object is within the area bound by the planform, it is within the planform, even if the object is at a different elevation than the base. Here, the lid assembly may be pivoted open to an open position at a right angle in relation to the orientation of the lid assembly in a closed position, and in the open position the lid assembly remains within the planform of the base. Additionally, in the closed position, the lid assembly remains within the planform of the base.

The lid assembly may include a first (e.g., upper) and second (e.g., lower) lid with a storage compartment disposed between them. A plurality of walls may extend from one of the first lid and second lid and define a compartment between the first lid and the second lid. One or more storage containers, each including a lid attached with a hinge, may be fixed to the second lid within the compartment.

A lid assembly locking mechanism may also be provided. The mechanism may include a lock assembly attached to the first lid and a strike plate with a bolt hole attached to the second lid within the compartment. The lock assembly aligns with the bolt hole when the first lid is in the closed position. A bolt of the lock assembly is movable between a locked position extending into the bolt hole and an unlocked position apart (withdrawn) from the bolt hole. A keyed lock core is provided to control locking and movement. The keyed lock core may include a lug movable from an extended position when the keyed lock core is locked to a retracted position when the keyed lock core is unlocked. In an extended position the lug engages a fixed structure (e.g., by extending into a hole formed in a fixed structure) that prevents movement of the bolt. In a retracted position the lug is apart from the fixed structure and the bolt is movable. The keyed lock core may be received in a sleeve. The bolt may be attached to and extend from an end of the sleeve. The sleeve may include a lug window in alignment with the lug of the lock core. The lug extends from the lug window in the extended position. The lug does not extend from the lug window in the retracted position. A lock receiver may be attached (fixed) to the second lid. The lock receiver includes a cylindrical channel in which the lock core and sleeve are received. A hole in the receiver aligns with the lug window. The hole is sized and shaped to receive the lug. When the lug is in an extended position, the lug extends from the lug window into the hole in the receiver, a fixed structure. Then, the lock core and sleeve are not free to move linearly within the receiver. When the lug is retracted by unlocking the lock core with a key, the lock core and sleeve may move linearly within the receiver. Such linear motion allows insertion of the bolt in the bolt hole of the strike plate for locking. It also allows removal of the bolt from the strike plate for unlocking. When the bolt is received in the bolt hole of the strike plate, the lug is aligned with hole in the receiver. The sleeve includes a narrow elongated fenestration extending longitudinally on an outer surface of the sleeve. The fenestration is aligned with a threaded channel in the lock receiver. A tip of a set screw in the threaded channel extends into the fenestration without preventing linear movement of the sleeve and the received lock core relative to the set screw. The length of the fenestration allows sufficient linear motion of the bolt between the unlocked position and the locked position. The fenestration and set screw also resist any rotation of the sleeve relative to the receiver, thereby ensuring that the lug will align with the hole in the receiver for locking.

The plurality of wall panels extending upwardly from the bottom panel may include a back wall panel and a front wall panel opposite the back wall panel. A flange at the top of the back wall panel may include a portion that is perpendicular to the back wall panel and extends from the back wall panel toward the front wall panel. The recessed hinge assembly may include a first hinge leaf (a hinge structure that is pivotally coupled to another hinge structure by a pivot pin) attached to the flange. Optionally, the flange may have a complex shape, such as an L-shape. The second lid may include a bent back edge (e.g., a U-shaped edge) defining an edge compartment. The recessed hinge assembly may include a second hinge leaf attached to the second lid in the edge compartment. The second leaf is pivotally coupled to the first leaf with a pivot pin.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a first perspective view of an exemplary embodiment of a job box with an open lid according to principles of the invention;

FIG. 2 is a second perspective view of an exemplary embodiment of a job box with an open lid according to principles of the invention;

FIG. 3 is side view of an exemplary embodiment of a job box with an open lid according to principles of the invention;

FIG. 4 is cutaway perspective view of an exemplary embodiment of a job box with an open lid according to principles of the invention;

FIG. 5 is a perspective exploded view of an exemplary hinge apparatus for an exemplary job box according to principles of the invention;

FIG. 6 is a profile view of an exemplary hinge apparatus on an exemplary job box lid and box according to principles of the invention;

FIG. 7 is a perspective view of an exemplary tool holder with an attached locking assembly for an exemplary job box according to principles of the invention;

FIG. 8 is a plan view of an exemplary lock assembly for an exemplary hinge apparatus for an exemplary job box according to principles of the invention;

FIG. 9 is a perspective view of an exemplary double-hinged lid in a closed configuration for an exemplary hinge apparatus for a job box according to principles of the invention;

FIG. 10 is a first perspective view of an exemplary double-hinged lid in a first opened configuration for an exemplary job box according to principles of the invention;

FIG. 11 is a second perspective view of an exemplary double-hinged lid in a first opened configuration for an exemplary job box according to principles of the invention;

FIG. 12 is a perspective view of an exemplary double-hinged lid in a second opened configuration for an exemplary job box according to principles of the invention;

FIG. 13 is a first perspective view of an exemplary locking mechanism in a locked configuration for a double-hinged lid for an exemplary job box according to principles of the invention;

FIG. 14 is a second perspective view of an exemplary locking mechanism in a locked configuration for a double-hinged lid for an exemplary job box according to principles of the invention;

FIG. 15 is a perspective view of an exemplary locking mechanism in an unlocked configuration for a double-hinged lid for an exemplary job box according to principles of the invention; and

FIGS. 16A-C are schematics that conceptually illustrate operation of a double-hinged lid for an exemplary job box according to principles of the invention.

FIG. 17 is a perspective view of an exemplary hinge bar assembly for an exemplary job box according to principles of the invention.

FIGS. 18A and 18B are perspective and profile views of the exemplary hinge bar assembly of FIG. 17 in a first open state for an exemplary job box according to principles of the invention.

FIGS. 19A and 19B are perspective and profile views of the exemplary hinge bar assembly of FIG. 17 in a second open state for an exemplary job box according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

An exemplary job box according to principles of the invention includes a box and a hinged lid. Each hinge that couples the lid to the box resides within the planform of the box, meaning it does not extend outside the planform (i.e., outside the area bound by the planform) when the hinge is closed, opened or between closed and opened. Additionally, each hinge includes a leaf that is nested in and attached to a U-shaped edge of the lid. Another leaf of the hinge is attached to the upper outer side of a ledge of the box structure. The two leaf structures are coupled with a pin, about which the leaf structures may pivot relative to each other. This hinge configuration allows the lid to be either flush (i.e., aligned) with the back panel of the box, or within the planform of the box, when the lid is opened. Thus, the job box may be positioned flush against a wall, without interfering with opening of the lid.

The lid may be a double hinged lid assembly. The double hinged lid assembly is hingedly coupled to the box as described above. The double lid assembly has an upper lid and a lower lid with flanged edges that define a compartment between lids. The compartment may store documents and house storage bins. Hinge bars reside along each side of the double hinged lid, between the upper lid and lower lid. The upper lid is pivotally coupled to the hinge bars near the front edge of the double hinged lid assembly. The lower lid is pivotally coupled to the hinge bars near the back edge of the double hinged lid assembly. This configuration allows the upper lid to be pivoted open along the front edge, or the upper lid and hinge bars to be pivoted open along the back edge. This enables the job box to serve as a podium with the upper lid tilted towards a user. It also enables the lid to be pivoted open to facilitate access to the compartment.

Locks are provided for securing the lid closed against the box, and for securing the upper lid closed against the lower lid of the double hinged lid assembly. The lock for the double hinged lid includes a strike plate mounted on the lower lid and a locking mechanism that includes a vending style lock core. The lock for securing the lid closed against the box includes a padlock with a restrained shackle and a body that moves to partially cover a passage through which a hook-shaped latch extends.

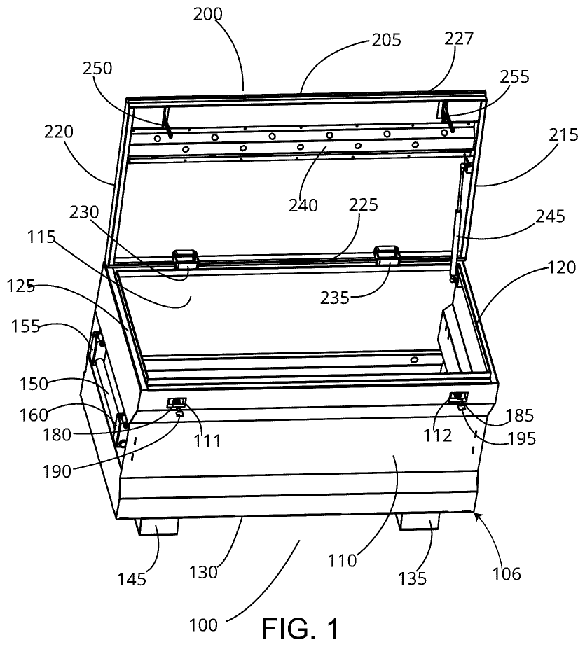

With reference to FIGS. 1-4, an exemplary job box 100 according to principles of the invention, includes a box-like structure 106 (base) with an open top. The base 106 is comprised of front 110, rear 115, side 120, 125 and bottom 130 wall panels. The panels may be separate panels that are joined together by welding or mechanical fastening during assembly. Alternatively, the panels may comprise portions of a sheet of metal that has been cut and then folded (bent) to the desired structural geometry. Seams may be welded or mechanically fastened.

Panels may include bends for structural enhancement and aesthetics. Forming bends and corrugations in a sheet of metal can significantly improve its structural properties by increasing its stiffness and resistance to deformation. Bends or corrugations effectively increase the distance of material from the neutral axis (the central line where the material experiences no tension or compression during bending), which increases the moment of inertia, making the sheet more resistant to bending. Corrugations and bends help distribute applied loads more evenly across the sheet, reducing stress concentration at any single point. This can prevent localized failure, such as buckling or cracking. Bends and corrugations increase the sheet's ability to withstand bending forces, making it less likely to deform under load. Reinforcements, such as hat-shaped beam 240, may be attached to a panel, such as panel 205, to enhance structural integrity.

The base 106 is supported on feet 135, 137, 145, 147 at the bottom of the box. The feet are configured to allow mechanical fastening to a bed of a truck or another stable surface. Thus, a hole and space is provided for a bolt to pass through the feet, and for a nut or bolt to be tightened using a wrench. The invention is not limited to any particular feet or method of attachment.

Locks 180, 185 and keys 190, 195 are provided for securing cantilever hook shaped latches 250, 255 extending from the bottom of the lid 200 in latching compartments. The compartments and locking are described below.

The lid 200 is secured to the base 106 with one or more hinges, such as hinges 230, 235. The structures of the job box 100 and the configuration of the hinges 230, 235 allow the lid 200 to be either flush (i.e., aligned) with the back panel of the box, or within the planform of the base 106, when the lid is opened. Thus, the job box 100 may be positioned flush against a wall, without interfering with opening of the lid 200. Details of the hinges 230, 235 and corresponding structure are described below.

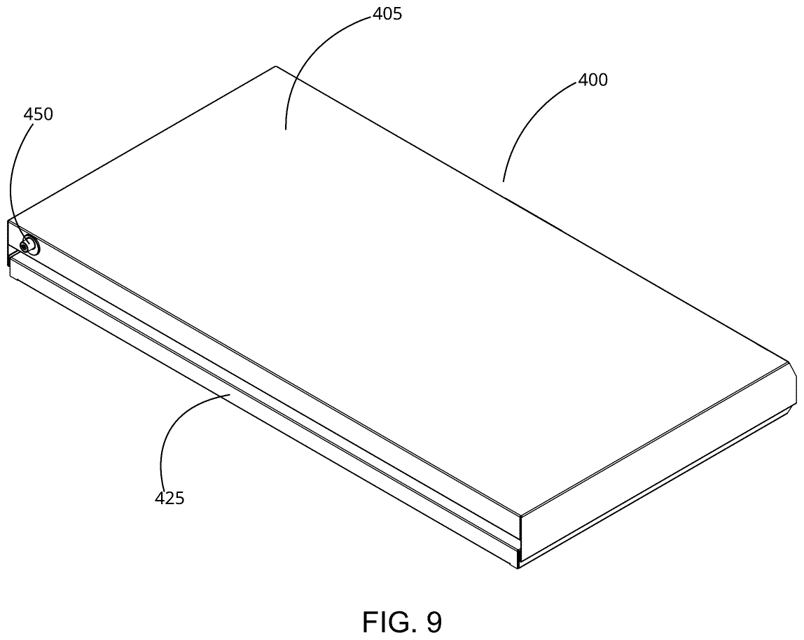

The invention is not limited to the lid 200 shown in FIGS. 1-4. Rather other, lids, such as the double hinged lid 400 shown in FIGS. 9-12 may be utilized within the spirit and scope of the invention. The lower lid 425 of the double hinged lid 400 is shaped like lid 200 shown in FIGS. 1-4, and may be attached using hinges 230, 235, as described above. The double hinged lid is described below.

Handles 150 are provided to facilitate carrying. While one handle is shown in FIGS. 1-4, the job box 100 is symmetric such that the opposite side panel includes an identical handle. The handles 150 are connected at recessed portions of each side panel 120, 125. The recesses provided structural enhancement, as discussed above, and also define compartments for receiving the handles 150 when not in use. Thus, the handles do not extend beyond the side panel when stored. In use, hinged couplings 155, 160 allow the handle to pivot from the recess compartment for easy gripping.

The lid 200 includes a panel 205 and front and rear edges and side edges 215, 220, 225, 227, to form a shallow compartment. The edges 215, 220, 225, 227 may be formed by bending, or may be separate structures attached to the lid by welding or mechanical fastening. The edges 215, 220, 225, 227 enhance the structural integrity of the lid 200, and provide good water resistance when similar edges from front 110, rear 115, side 120, 125 panels are received in the shallow compartment. Water running off the lid will not flow into the job box with this configuration.

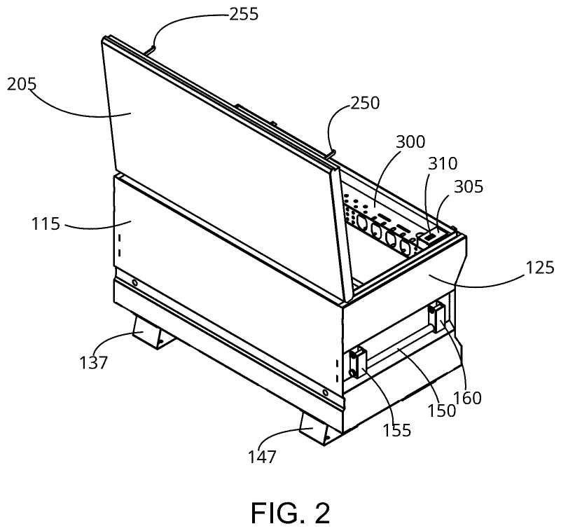

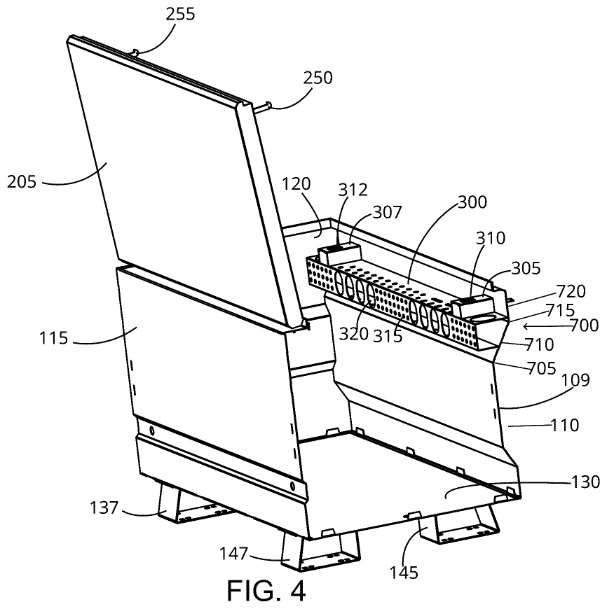

FIGS. 2 and 4 reveal a tool holder 300 with lock compartments 305, 307 and a latching windows 310, 312. The tool holder 300 is attached to the front panel 110. The tool holder 300 is a metal channel with a plurality of small 315 and large holes 320 for engaging tools or tool holding devices. The lock compartments 305, 307 are attached to the top of the tool holder 300, against the front panel 110, in alignment with windows 111, 112 in the front panel 110. The windows 111, 112 are sized and shaped for mating with the tool holder 300.

Referring to FIG. 4, the front wall panel 110 of the job box 100 is shaped with an upper compartment 700 (a concave formation) within which the tool holder 300 is disposed. In the exemplary embodiment, the compartment is defined by a first obtuse bend 705 leading to an askew portion 710. A second bend 715, equal in magnitude but opposite in direction to the first obtuse bend 705, leads to an upper portion 720. The upper portion 720 is in a plane that is parallel to but spaced apart from the plane of the central portion 109 of the front wall panel 110 that is disposed immediately below the first obtuse bend 705. The distance between the plane upper portion 720 and the plane of the central portion 109 is about equal to the width of the tool holder 300. Thus, the tool holder 300 is substantially received in the upper compartment. Notwithstanding the foregoing, the invention is not limited to defining the compartment with such bends and portions. Other bends, series of bends, curves and planar and curved portions may be combined to form a compartment without departing from the scope of the invention. Additionally, while the compartment is illustrated as an integral part of the front wall panel 110, a separate compartment structure that attaches the central portion 109 of the front wall panel 110 via welding or mechanical fastening may be utilized without departing from the scope of the invention.

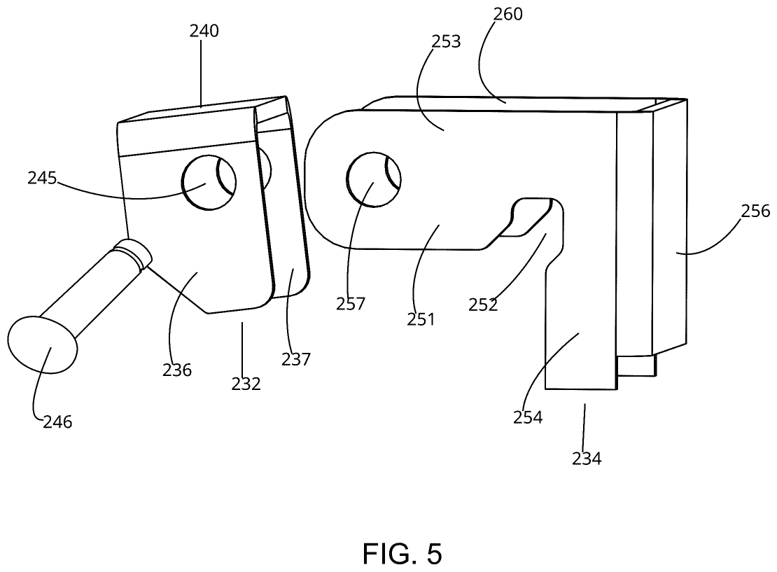

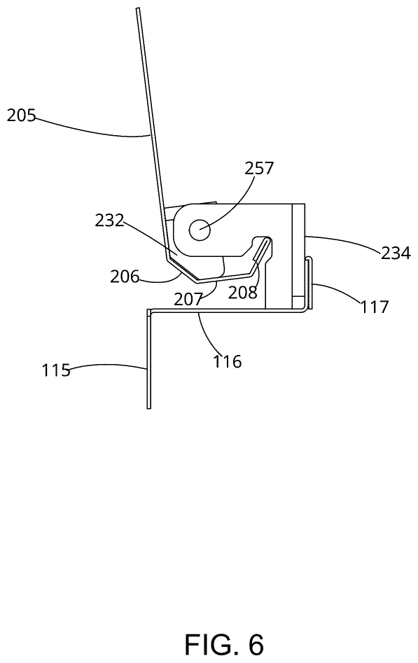

FIGS. 5 and 6 illustrate an exemplary hinge apparatus for an exemplary job box 100 according to principles of the invention. Two hinges 230, 235 are shown in FIG. 1. The hinges 230, 235 are identical. The hinges 230, 235 couple (i.e., hingedly couple) the lid 200 to the base 106. The hinges allow the lid 200 to open and close by pivoting about hinge pins. In the closed position, the lid 200 overlays the base 106, covering the open top of the base 106. In pivoting from the closed position to an open position, the lid exposes the open top of the base 106, allowing access to interior space of the base 106. The lid 200 may be raised to a position that is substantially parallel to the plane of back panel 115 of the base 106. When raised to such position, the lid is either aligned with the plane of back panel 115 of the base 106 or does not extend beyond the planform of the base 106. In other words, in a plan (top) view of the job box 100 with the lid 200 raised to a position that is substantially parallel to the plane of back panel 115 of the base 106, the lid 200 will not extend back (i.e., extend in a direction away from the front panel 110) beyond the plane of back panel 115 of the base 106. This hinge configuration allows the lid 200 to be either flush (i.e., aligned) with the back panel 115 of the base 106, or within the planform of the base 106, when the lid 200 is opened. Thus, the job box 100 may be positioned flush against a wall, without impeding opening of the lid 200.

An edge of the lid 205 is bent into a U-shape with two angled segments 206, 208, and, between the angled segments 206, 208, a segment 207 that is generally perpendicular to the lid 205. These segments 206-208 generally form a U-shape. A portion of each hinge is received and attached in the compartment defined by the segments.

Each hinge 230, 235 includes a first leaf 232 and a second leaf 234. A leaf is a component of a hinge assembly that attaches to an object and receives a pin for pivoting motion about the pin. A hinge assembly may include two leaves pivotally coupled by a pivot pin. The first leaf 232 and second leaf 234 include portions that overlap. A hinge pin 246 extends through aligned holes 245, 255. With a hinge pin 246 extending through the aligned holes 245, 255, the first leaf 232 and second leaf 234 may pivot about the hinge pin 246 in relation to each other. The first leaf 232 attaches to the lid 200. The second leaf 234 attaches to the base 106.

The first leaf 232 provides a stable structure for receiving a hinge pin 246, attaching to the lid 200, and overlapping a portion of the second leaf 234. In a nonlimiting example, the first leaf 232 includes a pair of parallel spaced apart side panels 236, 237, connected with a top lid 240. The side panels 236, 237 are identical. Each side panel includes an aligned hole 245. The holes are of equal diameter, a diameter suitable for receiving the hinge pin 246. The holes 245 are concentrically aligned. The first leaf 232 is located in and attached to the edge of the lid 205 that is bent into a U-shape. In the shown embodiment, the U-shape is formed with two angled segments 206, 208, and, between the angled segments 206, 208, a segment 207 that is generally perpendicular to the lid 205.

The second leaf 234 provides a stable structure for receiving a hinge pin 246, attaching to the base 106, and overlapping a portion of the first leaf 232. In a nonlimiting example, the second leaf 234 includes a pair of parallel spaced apart side panels 251, 260, connected with a front panel 256. The side panels 251, 260 are identical. Each side panel 251, 260 includes an aligned hole 257. The holes are of equal diameter, a diameter suitable for receiving the hinge pin 246. The holes 257 are concentrically aligned. Each side panel 251, 260 is generally L-shaped, with two segments 253, 254 meeting at a right angle. Each side panel 251, 260 includes a notch 252 at the junction of the segments 253, 254. The notch 252 is generally U-shaped, sized and configured to receive a free edge 208 of the panel 200 when the panel 200 is pivoted to an open position. The free edge notch 208 abuts an edge of the notch 252 when the panel is in a fully opened position. This abutment may be configured to limit the range of pivoting motion of the lid 200. If the lid 200 is pivoted to a vertical or beyond vertical position, e.g., the angle between horizontal and the panel 205 being 90° or slightly greater, the lid 200 should remain in that position, absent a counteracting force sufficient to move the lid 200.

The second leaf 234 attaches to an L-shaped flange at the top of the base 106. The L-shaped flange includes a horizontal segment 116 (horizontal wall) extending from lid 115 and a vertical segment 117 extending from the horizontal segment. The front panel 256 of the second leaf 234 abuts the vertical segment 117. The width of each assembled hinge 230, 235 is less than the width of segment 116, i.e., less than the distance between lid 115 and vertical segment 117.

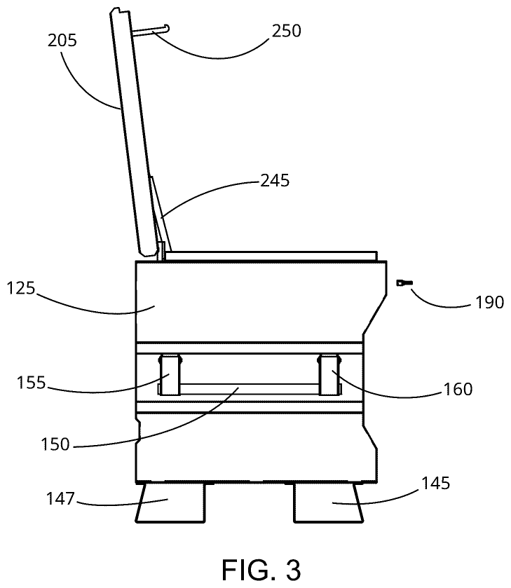

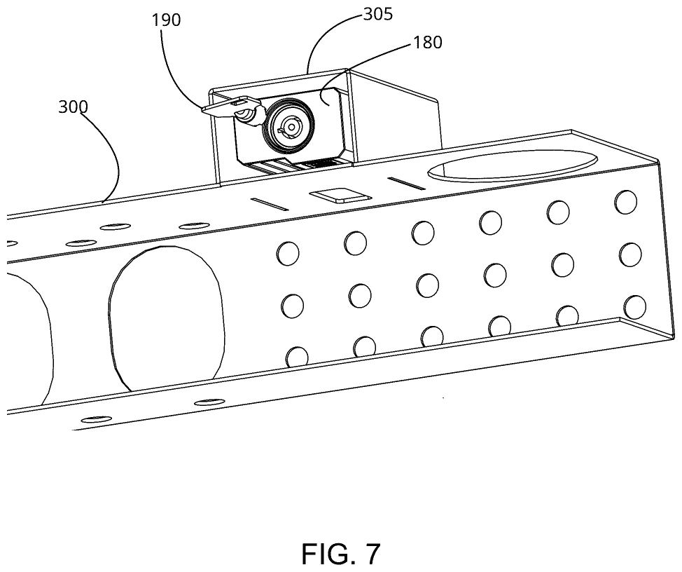

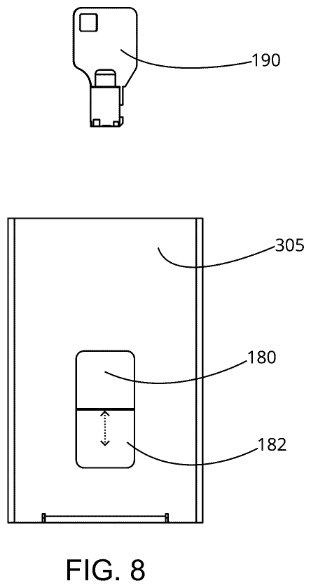

The lid 200 is locked in a closed position using latches 250, 255, lock compartments 305, 307 and padlocks. A shown in FIG. 3, the latches 250, 255 have a hook shape. The latches 250, 255 are identical. The free end of each latch is wider than the shank of each latch. As the lid 200 is closed, the free end of each latch 250, 255 passes through a window 310, 312 in a lock compartment 305, 307. Each lock compartment 305, 307 contains a padlock (FIGS. 1, 7 and 8). The shackle of each padlock is secured (fixed) in each lock compartment 305, 307. The body 180, 185 of each padlock moves in relation to each lock compartment 305, 307 and the window 310, 312. In the unlocked position, the body 180, 185 leaves the window sufficiently exposed to allow entry and removal of the free end of each latch 250, 255 without obstruction. However, when the lock is in a locked position, the body 180, 185 obstructs and prevents removal of the free end of each latch 250, 255 from the window 310, 312. Keys 190, 195 enable unlocking of the padlocks.

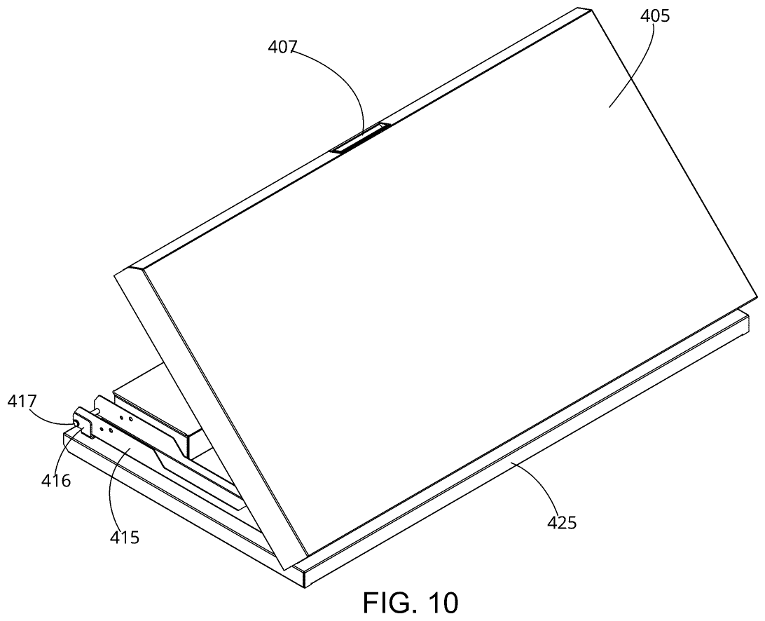

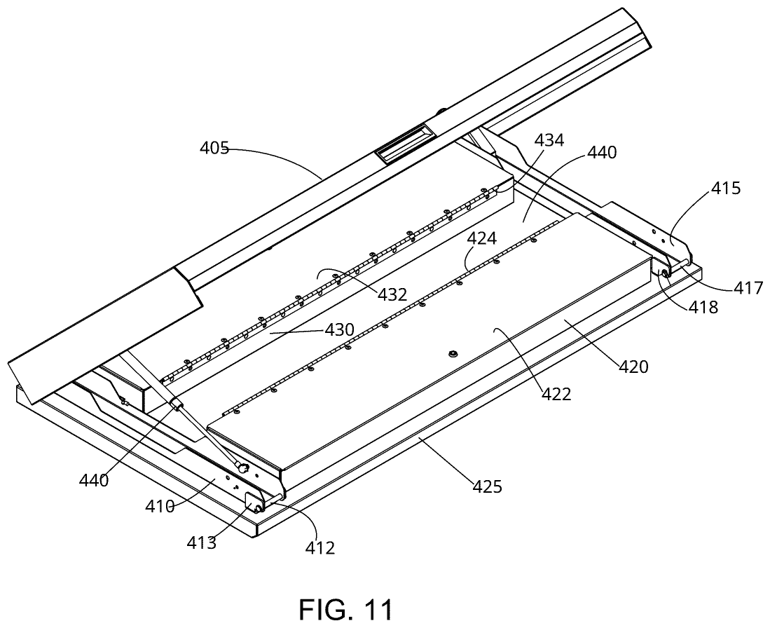

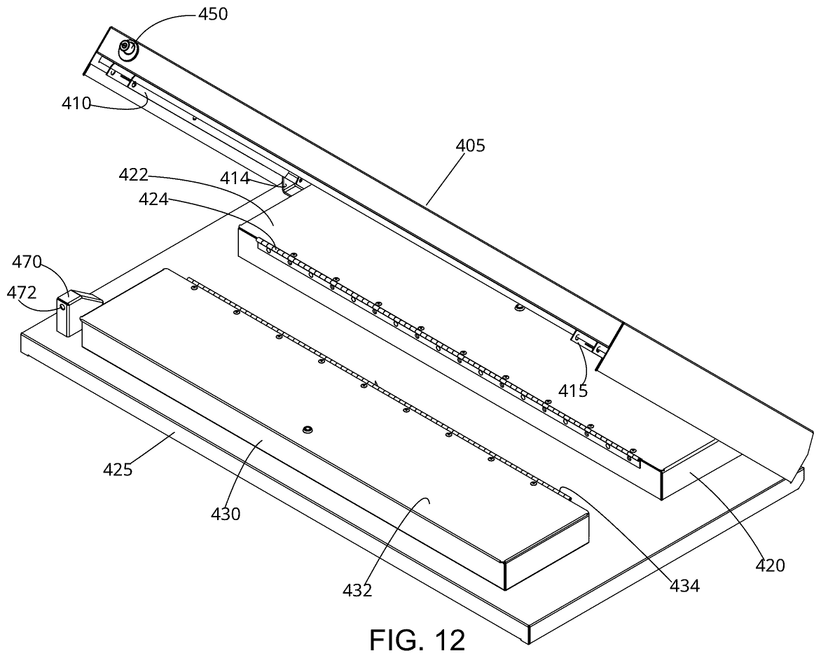

FIGS. 9-12 conceptually illustrate an exemplary double-hinged lid 400 in closed and opened configurations for an exemplary job box according to principles of the invention. The double-hinged lid 400 includes an upper lid 405 and a lower lid 425. The lower lid 425 is shaped and sized substantially the same as lid 200. Like lid 200, the lower lid 425 of the double-hinged lid 400 hingedly attaches to case 106 using hinges 230, 235. The upper lid 405 may pivot open from the lower lid 425 along two parallel spaced apart axes, one near the front of the lid 425 and the other near the back of the lid 425. In FIGS. 10 and 11, the lid 405 is pivoted open from the lower lid 425 along the front axis. In FIG. 12, the lid is pivoted open from the lower lid along the back axis.

The upper lid 405 includes flanged edges that define a shallow compartment. When the upper lid 405 is closed and substantially parallel to the lower lid 425, the lower lid 425 and the compartment defined by the upper lid define an enclosed volume for storing items. In one embodiment, storage containers are fixed to the top surface of the lower lid 425. Each storage container includes walls 420, 430 that form a generally rectangular prism body, a lid 422, 432, and a hinge 424, 434 that connects the lid 422, 432 to the container body. The invention is not limited to storage containers on the lower lid 425.

Hinge bars enable pivoting the upper lid 405 from the lower lid 425 along either of two opposite axes, one near the front of the lid 400 and one near the back of the lid. When the upper lid 405 is pivoted at the front edge as shown in FIGS. 10 and 11, the upper lid provides an inclined plane for supporting documents, in the manner of a podium.

Parallel spaced apart hinge bars 410, 415 extend along each side of the double hinged lid 400. At one end of the hinge bars 410, 415, the hinge bars 410, 415 are pivotally connected to brackets 413, 418 attached to the lower lid 425. At the opposite end of the hinge bars 410, 415, the hinge bars 410, 415 are pivotally connected to brackets 414 attached to the upper lid 405. One rear bracket 414 is visible in FIG. 12. An identical bracket is provided at the rear of the other hinge bar 415.

One or more gas struts 440 or springs are provided to assist in lifting the upper lid 405 and holding it open. The gas strut 440 is pivotally coupled at one end to the upper lid 405 and at the other end to the lower lid 425.

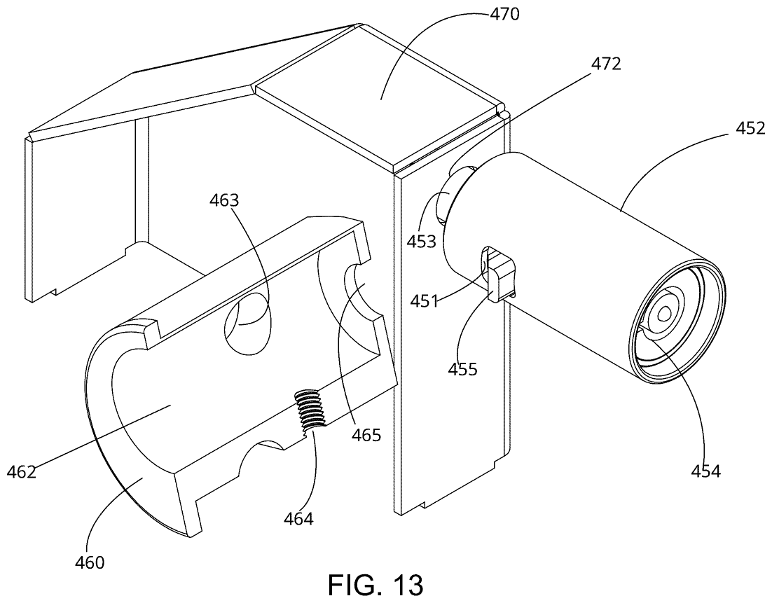

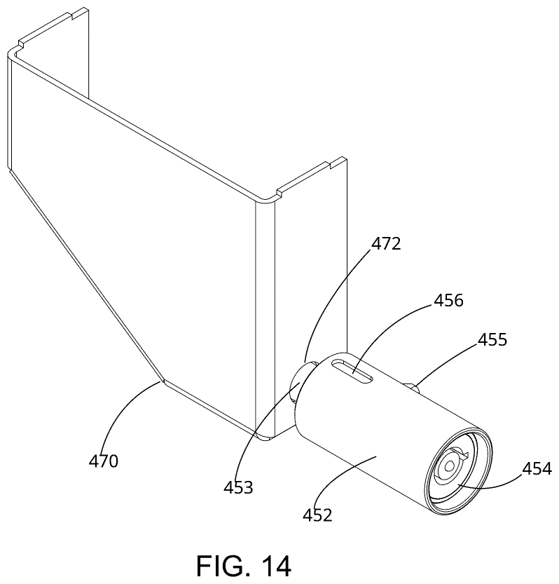

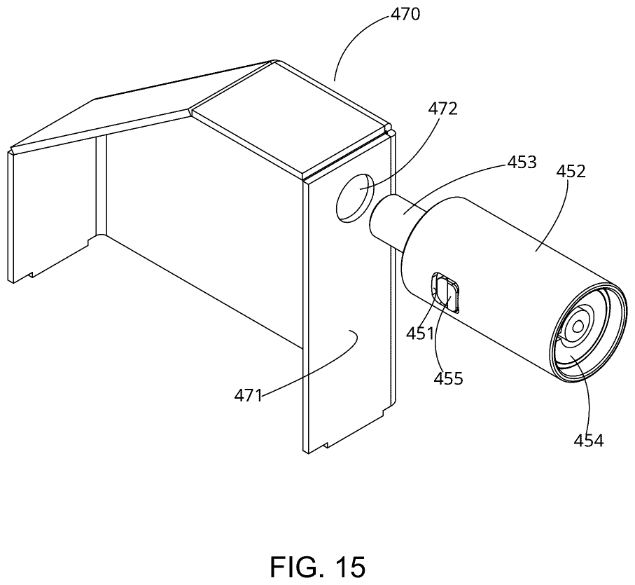

A locking mechanism is provided to secure the upper lid 405 in a locked (closed) position, substantially parallel to the lower lid 425. FIGS. 13-16 illustrate an exemplary locking mechanism. A portion of the locking mechanism is also shown in FIGS. 9 and 12. The locking mechanism includes a strike plate 470 with a hole 472 for receiving a bolt 453. The strike plate is attached to the lower lid 425. A hollow cylindrical receiver 460 (half of which is shown in FIG. 13 to reveal internal features) is fixed in an opening in the upper lid 405. The receiver 460 includes a cylindrical compartment 462, a back wall with a circular hole 465, a sidewall with a lug hole 463 or groove, and a threaded channel 464 for a set screw. The bolt 453 extends from a back end of a sleeve 452 that receives a lock core 454. The lock core 454 is received in the sleeve 452. Together, the lock core 454 and sleeve 452 are received in the receiver 460. In the exemplary embodiment, the lock core 454 is a vending style lock. The lock core 454 includes a lug 455 that aligns with a window 451 in the sleeve 452. When locked, the lug 455 extends through the window 451 into the lug hole 463 of the receiver 460. When unlocked, the lug 455 is about flush with the window 451. About flush means flush, proud by less than 1/16″ or extending into the window without extending beyond the exterior surface of the sleeve 452. The sleeve 452 includes a narrow peripheral fenestration 456 (e.g., a window or a groove). The fenestration 456 is elongated. The length of the fenestration 456 is about equal to or slightly less than the length of the cylindrical bolt 453. The fenestration 456 is aligned with a threaded channel 464. A tip of a set screw in the threaded channel 464 extends into the fenestration 456, but does not exert force against the sleeve 452 (or the contained lock core 454) that would prevent linear movement of the sleeve 452 (and the contained lock core 454) relative to the set screw. The length of the fenestration 456 allows linear motion of the bolt 453 from an unlocked position to a locked position. In the locked position, the cylindrical bolt 453 extends into the hole 472 of the strike plate 470. In the unlocked position, the cylindrical bolt 453 is withdrawn from the hole 472 of the strike plate 470. In the locked position, the bolt 453 and strike plate 470 prevent pivoting motion of the upper lid 405 relative to the lower lid 425.

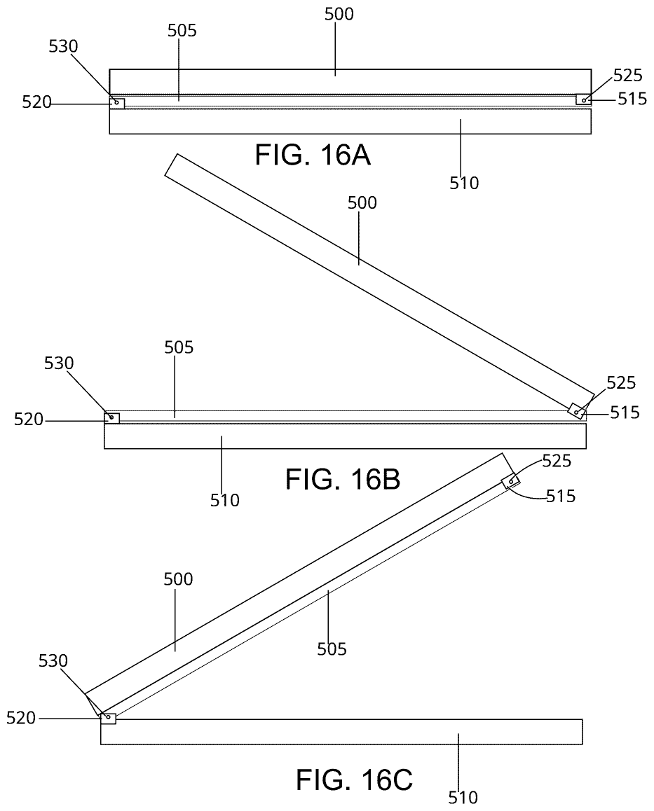

FIGS. 16A-C are schematics that conceptually illustrate operation of a double-hinged lid for an exemplary job box according to principles of the invention. The schematic shows two lids 500, 510; two brackets 515, 520; two hinge pins 525, 530 and a hinge bar 505. At each end, the hinge bar 505 is pivotally coupled to a bracket 515, 520 with a hinge pin 525, 530. At one end, the bracket 520 is fixed (attached) to the lower lid 510. At the opposite end, the bracket 515 is fixed to the upper lid 500. In FIG. 16A the upper lid 500 is in a closed position. In FIG. 16B, the upper lid has been opened by pivoting clockwise about pin 525. Bracket 515, which is fixed to the upper lid, has rotated with the upper lid 500. In FIG. 16B, the upper lid has been opened by pivoting counterclockwise about pin 530. Bracket 520, which is fixed to the lower lid, has not rotated with the upper lid 500. The hinge bar 505, which is pivotally coupled to bracket 515, has rotated with the upper lid 500. The arrangement of components illustrated in FIGS. 16A-16C provide a nonlimiting example of a particular hinge bar configuration. Other hinge bar configurations that allow pivoting rotation of a lid in opposite rotational directions about two parallel spaced apart axes are possible and come within the scope of the invention.

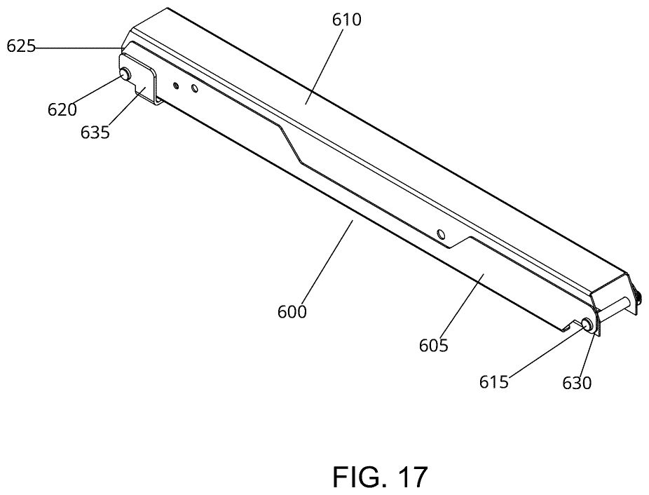

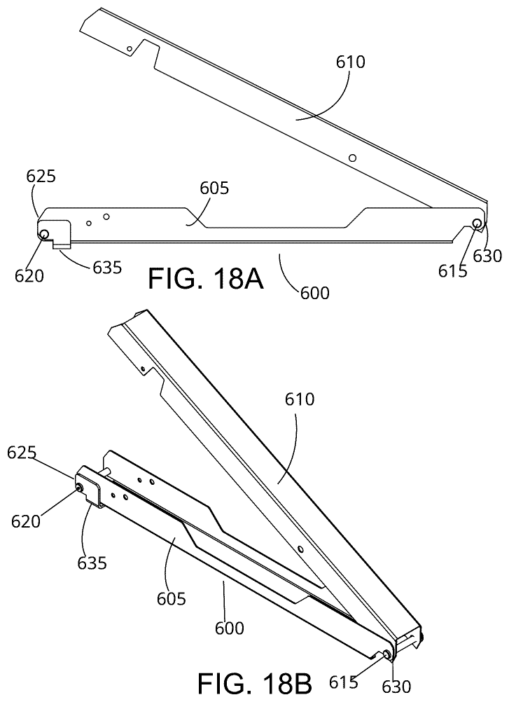

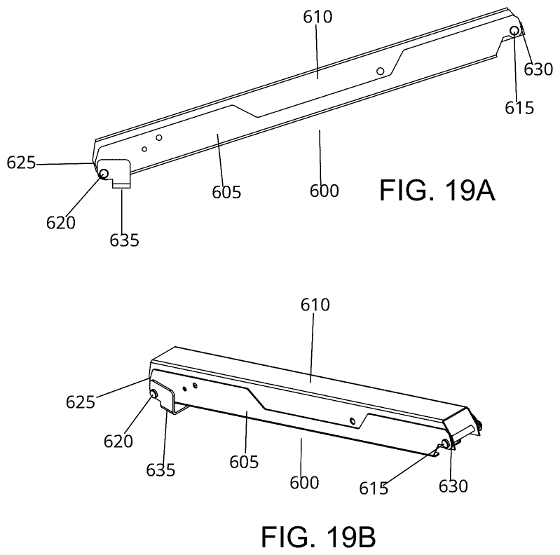

FIG. 17 is a perspective view of an exemplary hinge bar assembly 600 for an exemplary job box according to principles of the invention. The assembly includes two brackets 610, 635; two hinge pins 615, 620 and a hinge bar 605. The elongated bracket 610 also serves as a structural support beneath the lid 405 to which it attaches. At each end, the hinge bar 605 is pivotally coupled to a bracket 635, 610 with a hinge pin 615, 620. One bracket 610 may be fixed (attached) to one lid (e.g., an upper lid). The other bracket 635 may be fixed to another lid (e.g., a lower lid). The hinge pins 615, 620 define parallel spaced apart axes of rotation. One hinge pin 615 is near one end 630 of the hinge bar 605. The other hinge pin 620 is near the opposite end 625 of the hinge bar 605. The distance between the ends 625, 630 is not greater than the distance between the sides of the lids to which the assembly will be attached. In FIGS. 18A and 18B the upper bracket 610 has been pivoted clockwise about hinge pin 615. A lid attached to the upper bracket 610 would pivot the same. In FIGS. 19A and 19B, the upper bracket 610 and hinge bar 605 have been pivoted counterclockwise about hinge pin 620. Bracket 635, which may be fixed to a lid (e.g., a lower lid) does not rotate with the upper bracket 610 and hinge bar 605. A lid attached to the upper bracket 610 would pivot the same as the upper bracket 610 and hinge bar 605. In this manner, a double hinged lid assembly with two lids enables an upper lid to pivot about two spaced apart parallel axes of rotation in two opposite directions of rotation.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A job box mountable in a pickup truck bed comprising,
a base including a bottom panel and a plurality of wall panels extending upwardly from the bottom panel and defining a storage compartment with an open top;
a lid assembly hingedly coupled to the base and, in a closed position, covering the open top of the base, and in an open position, not covering at least a portion of the open top of the base,
the lid assembly comprising a first lid and at least one hinge bar, the at least one hinge bar having a first end pivotally coupled to the first lid at a first side of the first lid and a second end pivotally coupled to a structure below the first lid near a second side of the first lid, the first lid being pivotable relative to the structure below the first lid about each of two spaced apart parallel axes, including a first axis near the first side, and a second axis near the second side.

2. The job box mountable in a pickup truck bed according to claim 1, further comprising a first bracket coupled to the first lid and a first pivot pin coupling the first bracket to the first end of the hinge bar, a second bracket coupled to the structure below the first lid and a second pivot pin coupling the second bracket to the second end of the hinge bar.

3. The job box mountable in a pickup truck bed according to claim 1, wherein the at least one hinge bar includes two spaced apart parallel hinge bars with a first bracket pivotally coupled to the first lid near the first end of each hinge bar and a first pivot pin coupling the first bracket to near first end of each hinge bar, a second bracket coupled to the structure below the first lid near the second end of each hinge bar and a second pivot pin coupling the second bracket to the second end of each hinge bar.

4. The job box mountable in a pickup truck bed according to claim 1, wherein the structure below the first lid comprises a second lid disposed between the base and first lid, and the second lid of the lid assembly being hingedly coupled to the base, and the first lid being pivotable in relation to the second lid.

5. The job box mountable in a pickup truck bed according to claim 4, wherein the lid assembly is hingedly coupled to the base with at least one recessed hinge assembly within the planform of the base.

6. The job box mountable in a pickup truck bed according to claim 4, wherein the lid assembly may be pivoted to an open position, and in the open position the lid assembly being within the planform of the base.

7. The job box mountable in a pickup truck bed according to claim 6, wherein, in the closed position, the lid assembly being within the planform of the base.

8. The job box mountable in a pickup truck bed according to claim 4, further comprising a plurality of walls extending from one of the first lid and second lid and defining a compartment between the first lid and the second lid.

9. The job box mountable in a pickup truck bed according to claim 8, further comprising at least one storage container fixed to the second lid within the compartment.

10. The job box mountable in a pickup truck bed according to claim 9, the at least one storage container including a hinged lid.

11. The job box mountable in a pickup truck bed according to claim 8, further comprising a locking mechanism comprising a lock assembly attached to the first lid, and a strike plate with a bolt hole attached to the second lid within the compartment, wherein the lock assembly aligns with the bolt hole when the first lid is in the closed position.

12. The job box mountable in a pickup truck bed according to claim 11, wherein the lock assembly includes a bolt movable between a locked position extending into the bolt hole and an unlocked position apart from the bolt hole.

13. The job box mountable in a pickup truck bed according to claim 12, wherein the lock assembly further includes a keyed lock core.

14. The job box mountable in a pickup truck bed according to claim 13, wherein the keyed lock core includes a lug movable from an extended position when the keyed lock core is locked to a retracted position when the keyed lock core is unlocked, and in an extended position the lug engaging a fixed structure that prevents movement of the bolt, and in a retracted position the lug being apart from the fixed structure and the bolt being movable.

15. The job box mountable in a pickup truck bed according to claim 14, the keyed lock core being received in a sleeve, the bolt attached to and extending from an end of the sleeve, the sleeve including a lug window in alignment with the lug of the lock core, and the lug extending from the lug window in the extended position, and the lug not extending from the lug window in the retracted position.

16. The job box mountable in a pickup truck bed according to claim 15, a lock receiver attached to the second lid and the keyed lock core received in the sleeve being received in the lock receiver, and the fixed structure comprising a hole in the receiver in alignment with the lug window when the lug is in an extended position, and the lug extending from the lug window into the hole in the receiver when the lug is in an extended position.

17. The job box mountable in a pickup truck bed according to claim 16, the sleeve including a narrow elongated fenestration on an outer surface of the sleeve, the fenestration being aligned with a threaded channel in the lock receiver, a tip of a set screw in the threaded channel extending into the fenestration without preventing linear movement of the sleeve and the received lock core relative to the set screw, the length of the fenestration allowing linear motion of the bolt between the unlocked position and the locked position.

18. The job box mountable in a pickup truck bed according to claim 5, wherein the plurality of wall panels extending upwardly from the bottom panel include a back wall panel and a front wall panel opposite the back wall panel, a flange at the top of the back wall panel, the flange including a portion perpendicular to the back wall panel and extending from the back wall panel toward the front wall panel, and the recessed hinge assembly comprising a first hinge leaf attached to the flange.

19. The job box mountable in a pickup truck bed according to claim 18, the second lid including a bent back edge defining an edge compartment and the recessed hinge assembly further comprising a second hinge leaf attached to the second lid in the edge compartment.

20. The job box mountable in a pickup truck bed according to claim 19, the second leaf being pivotally coupled to the first leaf with a pivot pin.

21. A job box mountable in a pickup truck bed comprising,
a base including a bottom panel and a plurality of wall panels extending upwardly from the bottom panel and defining a storage compartment with an open top;
a lid assembly hingedly coupled to the base and, in a closed position, covering the open top of the base, and in an open position, not covering at least a portion of the open top of the base,
the base including a front wall panel with an upper portion, the upper portion defining an upper compartment, the compartment containing a tool holder, the tool holder.

22. The job box mountable in a pickup truck bed comprising according to claim 21, wherein the tool holder comprises a metal channel with a plurality of holes.

23. The job box mountable in a pickup truck bed comprising according to claim 21, wherein the upper compartment is an integral part of the front wall panel and the compartment is comprised a plurality of bends and a plurality of wall panel portions.

24. The job box mountable in a pickup truck bed comprising according to claim 23, wherein the plurality of bends include a first obtuse bend and a second bend, the second bend being equal in magnitude but opposite in direction to the first obtuse bend.
